(19) United States
(12) Patent Application Publication
(10) Pub. No.: US 2012/0236597 A1
(43) Pub. Date: Sep. 20, 2012

(54) LAMP AND FRAME MODULE THEREOF

(75) Inventors: CHIH-MING LIAO, TAOYUAN (TW); CHIH-MING TIEN, NEW TAIPEI CITY (TW); SZU-MING HUANG, TAIPEI CITY (TW); CHAO-KUN CHAN, TAOYUAN COUNTY (TW); JIH-SHENG HUANG, TAOYUAN COUNTY (TW); CHI-FU CHUANG, NEW TAIPEI CITY (TW)

(73) Assignee: ENLIGHT CORPORATION, TAOYUAN (TW)

(21) Appl. No.: 13/325,091

(22) Filed: Dec. 14, 2011

(30) Foreign Application Priority Data
Mar. 16, 2011 (TW) 100204676

(51) Int. Cl. F21V 8/00; F21V 7/20

(52) U.S. Cl. 362/612; 362/218

(57) ABSTRACT

A frame module includes a frame strip, a light emitting diode (LED) bar, and a fastener. The frame strip has a heat-dissipating portion, two elastic arms extended in one direction from the two edges of the heat-dissipating portion, and two pressing portions inwardly protruded form the two elastic arms. The heat-dissipating portion, the two elastic arms, and the two pressing portions define an accommodating trough. The LED bar has a printed circuit board (PCB) and a plurality of LEDs mounted on the PCB. The PCB is arranged in the accommodating trough of the frame strip and clamped between the heat-dissipating portion and the two pressing portions. The fastener is fixed on the two elastic arms. Thus, the heat generated form the LED bar is conducted by the LED bar directly contacting the frame strip. Besides, the instant disclosure also provides a lamp.

### BACKGROUND OF THE INVENTION

1. Field of the Invention

The instant disclosure relates to a lamp and a frame module thereof; and more particularly, to a frame module having a light emitting diode (LED) bar pressed by a frame strip to improve the heat conducting efficiency.

2. Description of Related Art

Light emitting diode (LED) is a solid-state semiconductor component that uses the electron-hole interaction to cause energy released in the form of light. LED is of cold light type, and is advantageous in its small size, fast response, good focusing property. long life, low power consumption and excellent shock resistance. In addition, LED has a plurality of environmental friendly advantages, such as without mercury, non-polluting and recyclable parts. The rise of environmental consciousness in today's society, LED is gradually replacing the traditional incandescent light sources and becoming the most popular choice of lighting device.

In use, the LED will generate a lot of heat and cause a high temperature, so that making light fade and reducing the service life of the LED. Thus, how to dissipating heat more quickly is an important issue for the LED development.

Conventional LED lamp often employs a frame strip, a LED bar mounted on one surface of the frame strip, and a heat conducting glue connected to the frame strip and the LED bar, so that the LED bar can be fixed on the frame strip via the heat conducting glue, and the heat generated from the LED bar can be transferred to the frame strip via the heat conducting glue. Thus, the opposing surface of the frame strip can dissipate the heat generated from the LED bar by convection through outer airflow.

However, the heat conducting efficiency of the heat conducting glue is often not as good as the heat conducting efficiency when the LED bar is in direct contact with the frame strip.

### SUMMARY OF THE INVENTION

One object of the instant disclosure is to provide a lamp and a frame module thereof, whereby the heat conducting efficiency of the LED bar can be improved, and the heat generated from the LED bar can be dissipated more quickly.

The frame module in accordance with the instant disclosure includes a frame strip, a light emitting diode (LED) bar, and a fastener. The frame strip has a heat-dissipating portion, two elastic arms extended in one direction from the two edges of the heat-dissipating portion, and two against portions inwardly protruded form the two elastic arms. The heat-dissipating portion, the two elastic arms, and the two against portions define an accommodating trough. The LED bar has a printed circuit board (PCB) and a plurality of LEDs mounted on the PCB. The PCB is arranged in the accommodating trough of the frame strip and clamped between the heat-dissipating portion and the two pressing portions. The fastener is fixed on the two elastic arms.

The lamp in accordance with the instant disclosure includes a frame module, a supporting frame, a transparent plate, a light guiding plate, a covering plate, and a reflecting layer. The frame module includes a frame strip, a LED bar, and a fastener. The frame strip has a heat-dissipating portion, two elastic arms extended in one direction from the two edges of the heat-dissipating portion, and two pressing portions inwardly protruded from the two elastic arms. The heat-dissipating portion, the two elastic arms, and the two pressing portions define an accommodating trough. The LED bar has a PCB and a plurality of LEDs mounted on the PCB. The PCB is arranged in the accommodating trough of the frame strip and clamped between the heat-dissipating portion and the two pressing portions. The fastener is fixed on the two elastic arms. The supporting frame is connected to the frame strip. The supporting frame and the frame strip define a circuit-shaped accommodating space. The outer portion of the transparent plate is arranged in the accommodating space, and one end portion of the transparent plate is disposed between the two elastic arms and contacted on one of the two elastic arms. The light guiding plate is disposed on the transparent plate. One end surface of the light guiding plate is faced to the LEDs. The outer portion of the covering plate is arranged in the accommodating space, and one end portion of the covering plate is disposed between the two elastic arms and contacted on the other elastic arm. The reflecting layer is disposed between the light guiding plate and the covering plate.

The LED bar of the frame module is clamped between the heat-dissipating portion and the pressing portion, whereby the heat generated from the LED bar can be transferred to the heat-dissipating portion by directly contacting, and then the heat can be transferred from the heat-dissipating portion to the elastic arms. Finally, the heat will be dissipated via the heat-dissipating portion and the elastic arms.

### BRIEF DESCRIPTION OF THE DRAWINGS

FIG. 1 is an exploded schematic view illustrating the first embodiment of the instant disclosure.

FIG. 2 is a schematic view illustrating the first embodiment of the instant disclosure.

FIG. 3 is a partial cutaway view illustrating the first embodiment of the instant disclosure.

FIG. 4 is the other partial cutaway view illustrating the first embodiment of the instant disclosure.

FIG. 5 is an exploded schematic view illustrating the second embodiment of the instant disclosure.

FIG. 6 is a schematic view illustrating the second embodiment of the instant disclosure.

FIG. 7 is a cutaway view illustrating the second embodiment of the instant disclosure.

FIG. 8 is a partial enlarged view of FIG. 7 of the instant disclosure.

### DETAILED DESCRIPTION OF THE PREFERRED EMBODIMENTS

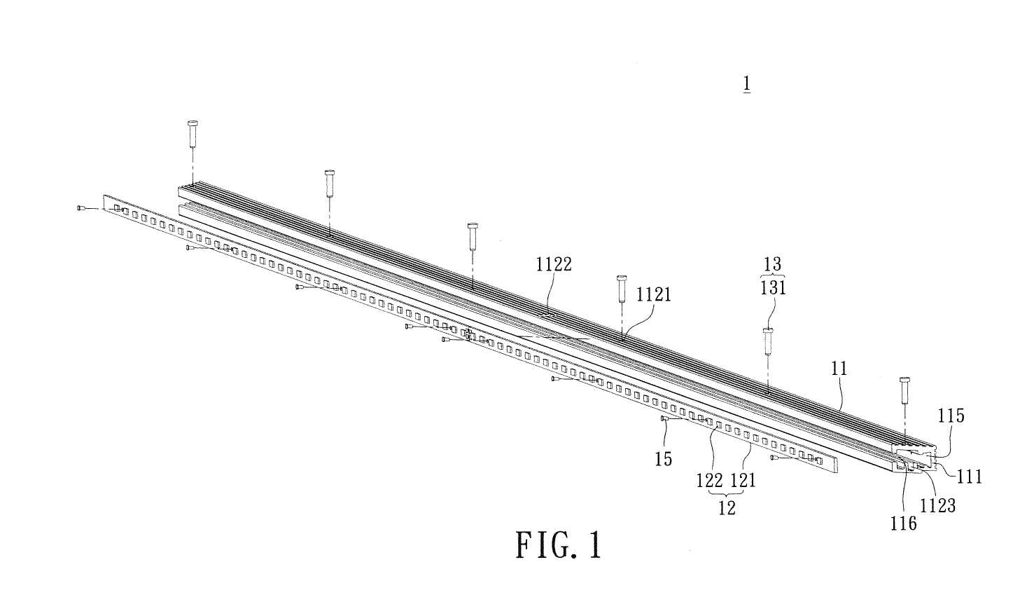

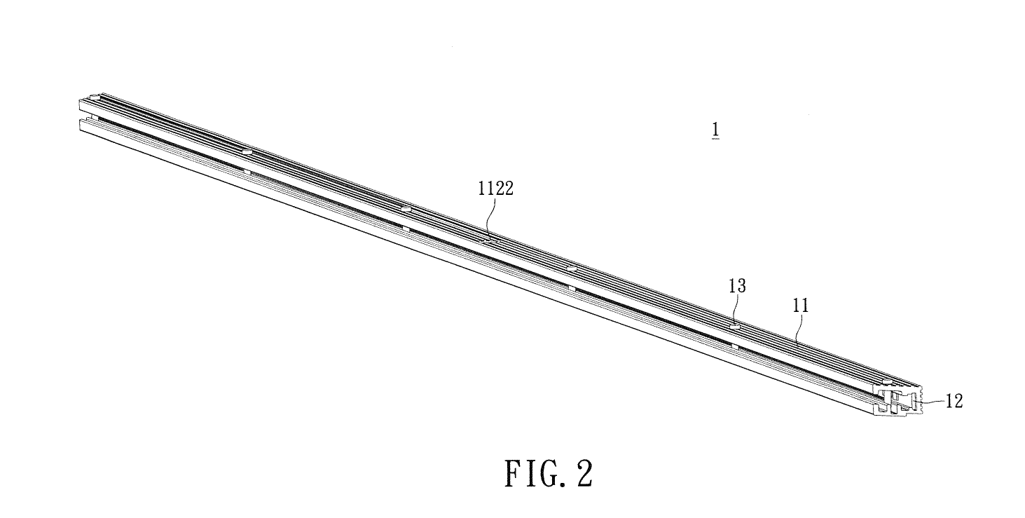

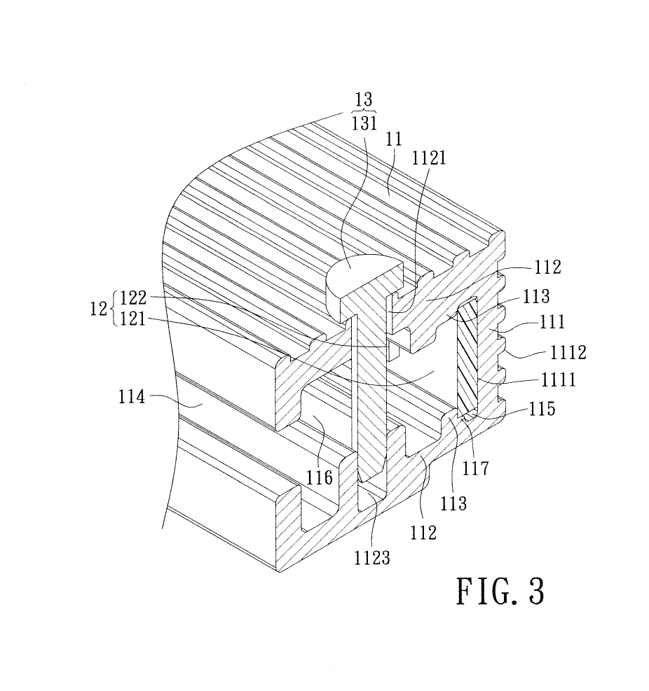

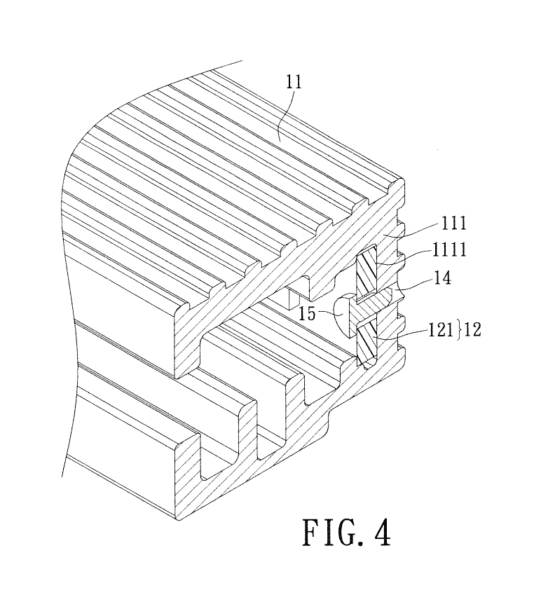

Please refer to FIGS. 1-4, which show the first embodiment of the instant disclosure, wherein FIGS. 1 and 2 are three-dimensional schematic view, and FIGS. 3 and 4 are cutaway schematic view.

As FIGS. 1 and 2 shown, a frame module 1 includes a frame strip 11, a LED bar 12 disposed inside the frame strip 11, and at least one fastener 13 disposed on the frame strip 11. The fastener 13 is fixed on the frame strip 11, so that the LED bar 12 is clamped in the frame strip 11.

As FIG. 3 shown, the frame strip 11 has a heat-dissipating portion 111, two elastic arms 112, and two pressing portions 113. The heat-dissipating portion 111 is strip-shaped. The heat-dissipating portion 111 has an inner surface 1111 and an outer surface 1112 formed oppositely. The inner surface 1111 is generally planar. The outer surface 1112 is trough-shaped, so that the heat-dissipating area of the outer surface 1112 can be increased to dissipate heat more quickly.

The two elastic arms 112 are extended in one direction from the two edges of the heat-dissipating portion 111. In more detail, the two elastic arms 112 are extended from the edges of the inner surface 1111 and the outer surface 1112 toward the direction away from the outer surface 1112 of the heat-dissipating portion 111. In addition, the outer ends of the two elastic arms 112 away from the outer surface 1112 define an opening 114, so that the two elastic arms 112 can be pressed toward each other inwardly.

One of the two elastic arms 112 has at least one fixing hole 1121 and a wire hole 1122 (as FIG. 1 shown). The fixing hole 1121 is used for passing the fastener 13, and the wire hole 1122 is used for passing a wire (not shown) connected to the LED bar 12. The other elastic arm 112 has a fixing trough 1123 corresponding to the fixing hole 1121.

The two pressing portions 113 inwardly protrude from the two elastic arms 112. The two pressing portions 113 are strip-shaped and parallel to the heat-dissipating portion 111. When the two elastic arms 112 are swing inwardly, the two pressing portions 113 are moving inwardly at the same time. However, in use, the shape of each pressing portions 113 is not limited thereto. For example, each pressing portion 113 can be a plurality of protruding bump structures (not shown).

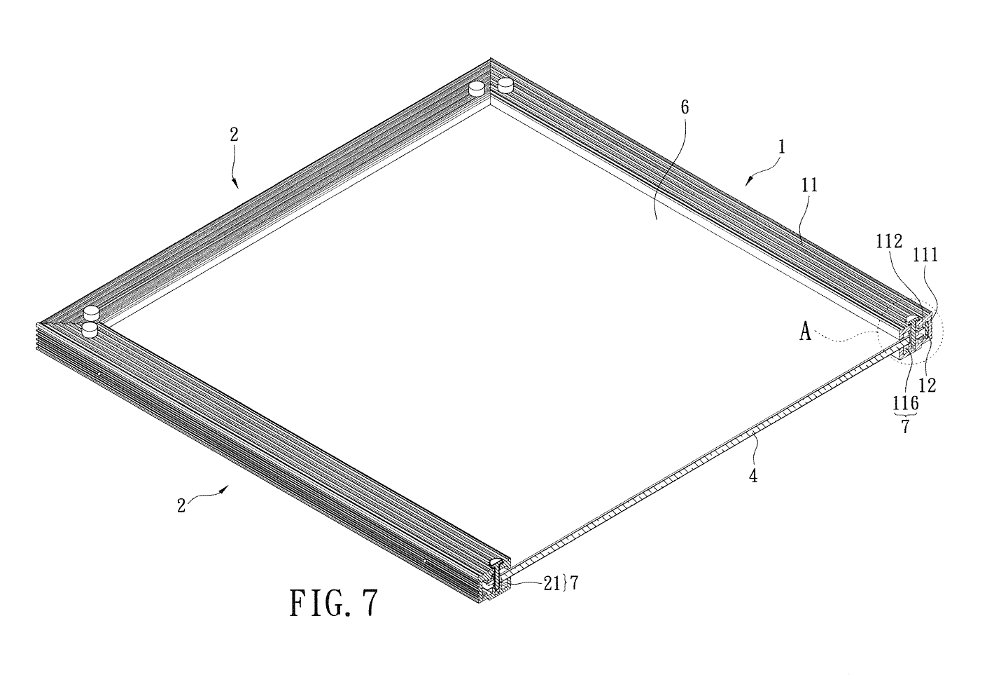

The heat-dissipating portion 111, the two elastic arms 112, and the two pressing portions 113 define an accommodating trough 115. The two elastic arms 112 and the two pressing portions 113 are define an inserting space 116 in communication with the opening 114, the fixing hole 1121, the fixing trough 1123, and the accommodating trough 115. The inserting space 116 is used for inserting a light guiding plate 4 (as FIG. 7 shown).

One of the two elastic arms 112 has a resisting portion 117 protruded therefrom and extended into the accommodating trough 115. The resisting portion 117 is strip-shaped in the first embodiment. However, in use, the shape of each resisting portion 117 is not limited thereto. For example, each resisting portion 117 can be bump-shaped (not shown). In addition, the resisting portion 117 can be connected to the pressing portion 113.

Moreover, the frame strip 11 is made by a material, which capacity of good heat conducting efficiency. The better choice for the material of the frame strip 11 is aluminum, but in use, the material is not limited thereto.

The LED bar 12 has a printed circuit board (PCB) 121 and a plurality of LEDs 122 mounted on the PCB 121. The PCB 121 is arranged in the accommodating trough 115 of the frame strip 11, the PCB 121 is clamped between the heat-dissipating portion 111 and the two pressing portions 113, and the PCB 121 can be maintained the position by the resisting portion 117. In addition, the number of the LED bar 12, which arranged in the accommodating trough 113 of the frame strip 11, can be changed by the user's and the designer's demand.

The fastener 13 is fixed on the elastic arms 112, so that the LED bar can be pressed by the pressing portion 113, thereby causing the inner surface 1111 of the heat-dissipating portion 111 evenly contacted on the PCB 121 of the LED bar 12. Thus, the heat generated from the LED bar 12 can be transferred to the heat-dissipating portion 111 by directly contacting, and then the heat can be transferred from the heat-dissipating portion 111 to the elastic arms 112. Finally, the heat will be dissipated via the heat-dissipating portion 111 and the elastic arms 112.

In more detail, the fastener 13 can be a screw 131. The screw 131 passes through the fixing hole 1121 of the elastic arm 112, and then locking on the lateral walls beside the fixing trough 1123. During the locking process, the depth of the screw 111 locking into the fixing trough 1123 can be adjusted to decide the swing range of the elastic arms 112, so that the pressing portion 113 can press on the LED bar with suitable active force. Thus, the inner surface 1111 of the heat-dissipating portion 111 can be evenly contacted on the PCB 121 of the LED bar 12. However, in use, the fastener 13 is not limited to the screw 131.

As FIG. 4 shown, in order to increase the contact area between the inner surface 1111 of the heat-dissipating portion 111 and the PCB 121 of the LED bar 12, the frame module 1 has a fixing component 15 (such as screw) and a through hole 14 formed on the PCB 121 and the heat-dissipating portion 111. The fixing component 15 is passed through the through hole 14 and fixed on the lateral wall beside the through hole 14, whereby the PCB 121 can establish even contact with the inner surface 1111 of the heat-dissipating portion 111 by the fixing component 15.

In practice, the fixing component 15 can be screw, rivet, cotter pin, spring pin, R-shaped pin, or the other component capacity of fixing function.

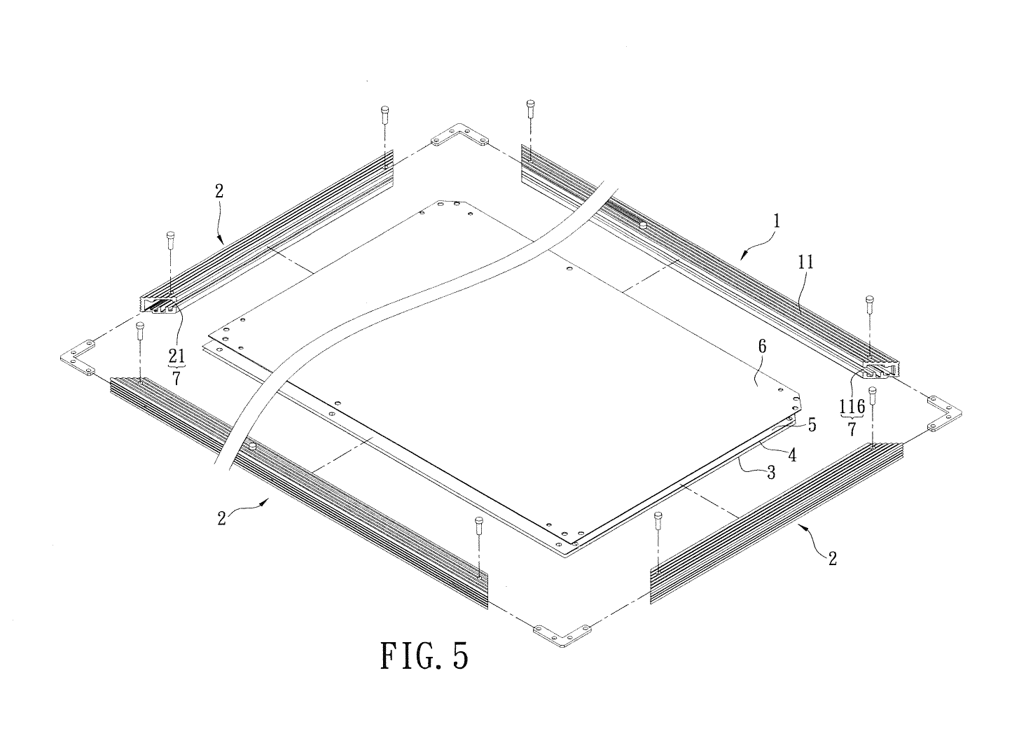

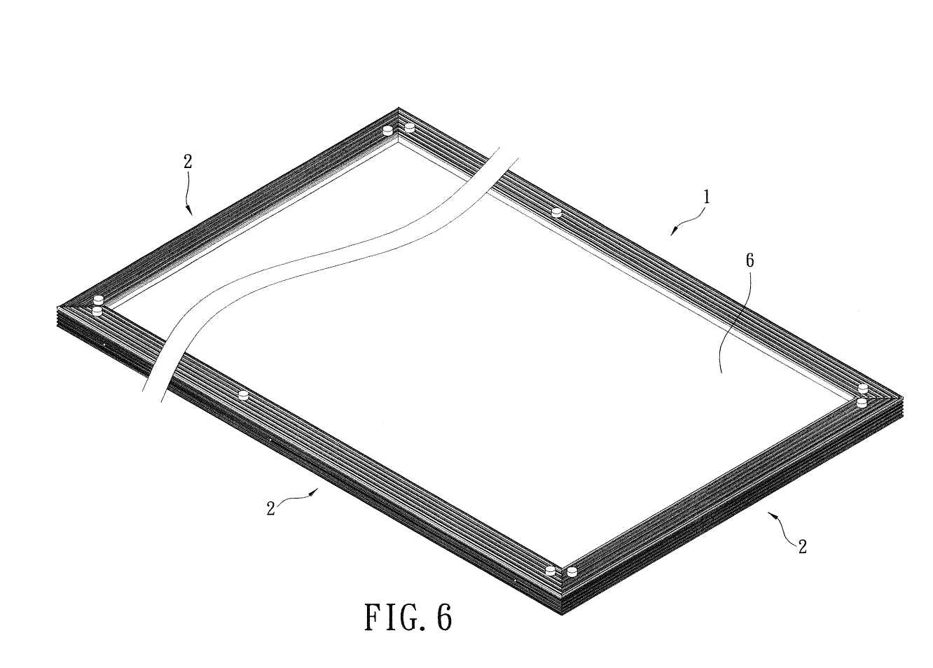

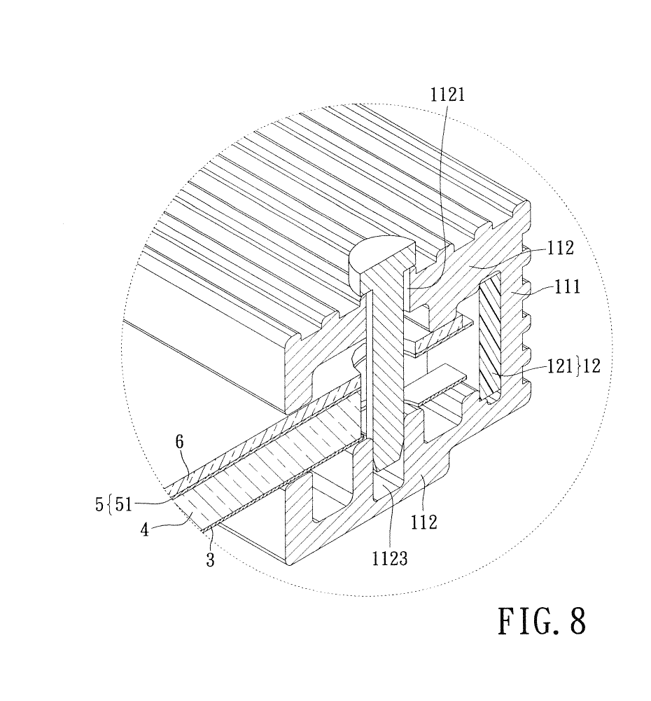

Please refer to FIGS. 5-8, which show the second embodiment of the instant disclosure, wherein FIGS. 5 and 6 are three-dimensional schematic view, and FIGS. 7 and 8 are cutaway schematic view.

The difference between the second and the first embodiments are as follows. The second embodiment discloses a lamp. The lamp has the frame module 1 (such as the first embodiment disclosed) to provide illumination. The lamp has one frame module 1 in the second embodiment. However, in use, the lamp can have more than one frame module 1.

As FIGS. 5 and 6 shown, the lamp includes the frame module 1, a supporting frame 2, a transparent plate 3, a light guiding plate 4 (as FIG. 8 shown), a reflecting layer 5, and a covering plate 6. The transparent plate 3, the light guiding plate 4, the reflecting layer 5, and the covering plate 6 are mounted in the frame module 1 and the supporting frame 2.

As FIGS. 5 and 7 shown, the supporting frame 2 is connected to the frame strip 11. The supporting frame 2 and the frame strip 11 define a circuit-shaped accommodating space 7. That is to say, the supporting frame 2 has a trough 21 formed inside thereof, and the trough 21 is communicated with the inserting space 116 to form the circuit-shaped accommodating space 7. In more detail, the supporting frame 2 can be made by connecting three strip structures, which is similar to the frame strip 11.

Thus, the heat generated from the LED bar 12 can be transferred to the heat-dissipating portion 111 by directly contacting, and then the heat can be transferred from the heat-dissipating portion 111 to the elastic arms 112 and the supporting frame 2. Finally, the heat will be dissipated via the heat-dissipating portion 111, the elastic arms 112, and the supporting frame 2.

As FIGS. 5 and 8 shown, the outer portion of the transparent plate 3 is arranged in the accommodating space 7, and one end portion of the transparent plate 3 is disposed between the two elastic arms 112 and contacted on one of the two elastic arms 112. In more detail, one end portion of the transparent plate 3 is contacted on the elastic arm 112, which has the fixing trough 1123. In addition, the transparent plate 3 can be capacity of light uniform function, such as alveolus transparent plate (not shown).

The light guiding plate 4 is disposed on the transparent plate 3. One of the end surfaces of the light guiding plate 4 faces toward the LEDs 122 of the frame module 1, so that the light generated from the LEDs can be emitted into the light guiding plate 4.

The outer portion of the covering plate 6 is arranged in the accommodating space 7, and one end portion of the covering plate 6 is disposed between the two elastic arms 112 and contacted on the other elastic arm 112. In more detail, one end portion of the covering plate 6 is contacted on the elastic arm 112, which has the fixing hole 1121.

The reflecting layer 5 is disposed between the light guiding plate 4 and the covering plate 6. In the second embodiment, the reflecting layer 5 is a reflecting sheet 51 clamped between the light guiding plate 4 and the covering plate 6. However, in use, the reflecting layer 5 can be coated on one surface of the light guiding plate 4 corresponding to the covering plate 6, or the reflecting layer 5 can be coated on one surface of the covering plate 6 corresponding to the light guiding plate 4. Thus, the light emitted into the light guiding plate 4 is reflected by the reflecting layer 5 to reduce the light loss, so that when the light emitted out of the light guiding plate 4 can be maintained the light strength.

Based on the above, the LED bar 12 is clamped between the heat-dissipating portion 111 and the pressing portion 113, whereby the heat generated from the LED bar 12 can be transferred to the heat-dissipating portion 111 by directly contacting, and then the heat can be transferred from the heat-dissipating portion 111 to the elastic arms 112. Finally, the heat will be dissipated via the heat-dissipating portion 111 and the elastic arms 112. Moreover, the heat dissipating area of the lamp can be increased via the supporting frame 2.

In addition, the PCB 121 can be fixed on the inner surface 1111 of the heat-dissipating portion 111 by the fixing component 15 in order to increase the contacting area between the inner surface 1111 of the heat-dissipating portion 111 and the PCB 121 of the LED bar 12, thereby increasing the heat dissipating efficiency.

The description above only illustrates specific embodiments and examples of the instant disclosure. The instant disclosure should therefore cover various modifications and variations made to the herein-described structure and operations of the instant disclosure, provided they fall within the scope of the instant disclosure as defined in the following appended claims.

What is claimed is:

1. A frame module of a lamp, comprising:
a frame strip having a heat-dissipating portion, two elastic arms extended in one direction from the two edges of the heat-dissipating portion, and two pressing portions inwardly protruding from the two elastic arms,
wherein the heat-dissipating portion, the two elastic arms, and the two pressing portions define an accommodating trough;
a light emitting diode (LED) bar having a printed circuit board (PCB) and a plurality of LEDs mounted on the PCB,
wherein the PCB is arranged in the accommodating trough of the frame strip and clamped between the heat-dissipating portion and the two pressing portions; and
a fastener fixed on the two elastic arms.

2. The frame module as claimed in claim 1, wherein the heat-dissipating portion and the two pressing portions are strip-shaped, and the two pressing portions are parallel to the heat-dissipating portion.

3. The frame module as claimed in claim 1, wherein the two elastic arms and the two pressing portions are define an inserting space in communication with the accommodating trough.

4. The frame module as claimed in claim 3, wherein one of the two elastic arms has a fixing hole, and the other elastic arm has a fixing trough corresponding to the fixing hole, the fixing hole and the fixing trough are in communication with the accommodating trough, the fastener is passing through the fixing hole and the accommodating trough to fix in the fixing trough.

5. The frame module as claimed in claim 4, wherein one of the two elastic arms has a resisting portion protruded therefrom to the accommodating trough, the resisting portion contacts on the PCB of the LED bar.

6. The frame module as claimed in claim 5, wherein a through hole is formed on the PCB and the heat-dissipating portion, the frame module has a fixing component passed through the through hole, causing the PCB evenly contacted on the inner surface of the heat-dissipating portion.

7. The frame module as claimed in claim 1, wherein the PCB is evenly contacted on the inner surface of the heat-dissipating portion.

8. The frame module as claimed in claim 1, wherein one of the two elastic arms has a wire hole.

9. A lamp, comprising:
a frame module having:
a frame strip having a heat-dissipating portion, two elastic arms extended in one direction from the two edges of the heat-dissipating portion, and two pressing portions inwardly protruded from the two elastic arms,
wherein the heat-dissipating portion, the two elastic arms, and the two pressing portions define an accommodating trough;
a light emitting diode (LED) bar having a printed circuit board (PCB) and a plurality of LEDs mounted on the PCB,
wherein the PCB is arranged in the accommodating trough of the frame strip and clamped between the .heat-dissipating portion and the two pressing portions; and
a fastener fixed on the two elastic arms;
a supporting frame connected to the frame strip,
wherein the supporting frame and the frame strip define a circuit-shaped accommodating space;
a transparent plate,
wherein the outer portion of the transparent plate is arranged in the accommodating space, and one end portion of the transparent plate is disposed between the two elastic arms and contacted on one of the two elastic arms.
a light guiding plate disposed on the transparent plate,
wherein one end surface of the light guiding plate is faced to the LEDs;
a covering plate,
wherein the outer portion of the covering plate is arranged in the accommodating space, and the one end portion of the covering plate is disposed between the two elastic arms and contacted on the other elastic arm.; and
a reflecting layer disposed between the light guiding plate and the covering plate.

10. The lamp as claimed in claim 9, wherein the reflecting layer is a reflecting sheet clamped between the light guiding plate and the covering plate.
